(19) United States
(12) Patent Application Publication
(10) Pub. No.: US 2026/0098744 A1
(43) Pub. Date: Apr. 9, 2026

(54) CONFIGURABLE MAP TILE POLYGONS FOR LOCATION-BASED ANALYTICS

(71) Applicant: Authur Paul Drennan, III, Avon, CT (US)

(72) Inventor: Authur Paul Drennan, III, Avon, CT (US)

(21) Appl. No.: 18/908,081

(22) Filed: Oct. 7, 2024

(51) Int. Cl. G01C 21/00; G06Q 40/08

(52) U.S. Cl. CPC G01C 21/3867; G01C 21/3878; G01C 21/3881; G06Q 40/08

(57) ABSTRACT

A system for location-based analytics may include a location map data store containing electronic records that are associated with a plurality of configurable map tile polygons defining a location map. Each record may include, for example, a unique map tile identifier and a set of locations representing sides of a polygon for that configurable map tile. A location analyzer may overlay location-based information on the configurable map tile polygons that define the location map. The location analyzer can then automatically correlate the configurable map tile polygons that define the location map and the location-based information to determine at least one characteristic of each configurable map tile identifier. According to some embodiments an action is automatically performed based on the determined characteristic.

### TECHNICAL FIELD

The present application generally relates to computer systems and more particularly to computer systems that are adapted to accurately, securely, and/or automatically support configurable map tile polygons for location-based analytics.

### BACKGROUND

An enterprise may want to analyze location-based information. For example, different areas in as map might be associated with different characteristics (e.g., different types of buildings, different rules and regulations, different access to resources, etc.) that the enterprise is interested in understanding. It is known, for example, that a map of a country might be broken into states, states might be broken into counties, etc. Moreover, postal addresses may provide insight into an area at the level of individual buildings. Such approaches, however, are not configurable making it difficult to overlay location-based information from various sources, customize areas on a map, track changes over time, etc.

It would be desirable to provide improved systems and methods to accurately and/or automatically support location-based analysis for an enterprise. Moreover, the results should be easy to access, understand, interpret, update, etc.

### SUMMARY OF THE INVENTION

According to some embodiments, systems, methods, apparatus, computer program code and means are provided to accurately and/or automatically support location-based analysis for an enterprise in a way that provides fast, secure, and useful results and that allows for flexibility and effectiveness when responding to those results.

Some embodiments are directed to a system for location-based analytics that includes a location map data store containing electronic records associated with a plurality of configurable map tile polygons defining a location map. Each record may include, for example, a unique map tile identifier and a set of locations representing sides of a polygon for that configurable map tile. A location analyzer may overlay location-based information on the configurable map tile polygons that define the location map. The location analyzer can then automatically correlate the configurable map tile polygons that define the location map and the location-based information to determine at least one characteristic of each configurable map tile identifier. According to some embodiments an action is automatically performed based on the determined characteristic.

Some embodiments comprise: means for accessing a location map data store that contains electronic records associated with a plurality of configurable map tile polygons defining a location map, each record including a unique map tile identifier and a set of locations representing sides of a polygon for that configurable map tile; means for overlaying, by a computer processor of a location analyzer in a back-end application computer server, location-based information on the configurable map tile polygons that define the location map; means for automatically correlating the configurable map tile polygons that define the location map and the location-based information to determine at least one characteristic of each configurable map tile identifier; and means for automatically performing an action based on the determined characteristic.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized support of location-based analysis that provides fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1A is a location map in accordance with some embodiments.

FIG. 1B is a configurable map tile polygon according to some embodiments.

FIG. 1C illustrates overlaying and correlating information according to some embodiments.

FIG. 2 is a high-level block diagram of an enterprise system in accordance with some embodiments.

FIG. 3 illustrates a method according to some embodiments.

FIGS. 4A through 4C are various ways of configuring a map tile polygon in accordance with some embodiments.

FIG. 5 is a three-dimensional polygon according to some embodiments.

FIG. 6 are map tile polygon layers in accordance with some embodiments.

FIG. 7 is a map tile polygon hierarchy according to some embodiments.

FIG. 8 is a temporary map tile polygon in accordance with some embodiments.

FIGS. 9A and 9B are illustrations of location maps according to some embodiments.

FIGS. 10A and 10B are tile polygons in accordance with other embodiments.

FIG. 11 is an insurance related method according to some embodiments.

FIG. 12 is an operator or administrator display according to some embodiments.

FIG. 13 is a block diagram of an apparatus in accordance with some embodiments.

FIG. 14 is a portion of a location map data store according to some embodiments.

FIG. 15 is a tablet computer according to some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with a location-based analytics system. The present invention is directed to more than merely a computer implementation of a routine or conventional activity previously known in the industry as it provides a specific advancement in the area of location-based analysis by providing improvements in the operation of a computer system that automatically implements location maps. The present invention provides improvement beyond a mere generic computer implementation as it involves the novel ordered combination of system elements and processes to provide improvements in the speed, security, and accuracy of such a location analyzer for an enterprise. Some embodiments of the present invention are directed to a system adapted to automatically handle location maps changes, aggregate data from multiple data sources, automatically generate alerts to reduce unnecessary messages or communications, etc. (e.g., to consolidate communications between parties within an enterprise). Moreover, communication links and messages may be automatically established, aggregated, formatted, modified, removed, exchanged, etc. to improve network performance (e.g., by reducing an amount of network messaging bandwidth and/or storage required to create location-based analysis messages or alerts, improve security, reduce the size of data stores, more efficiently collect, present, and utilize location map information, etc.).

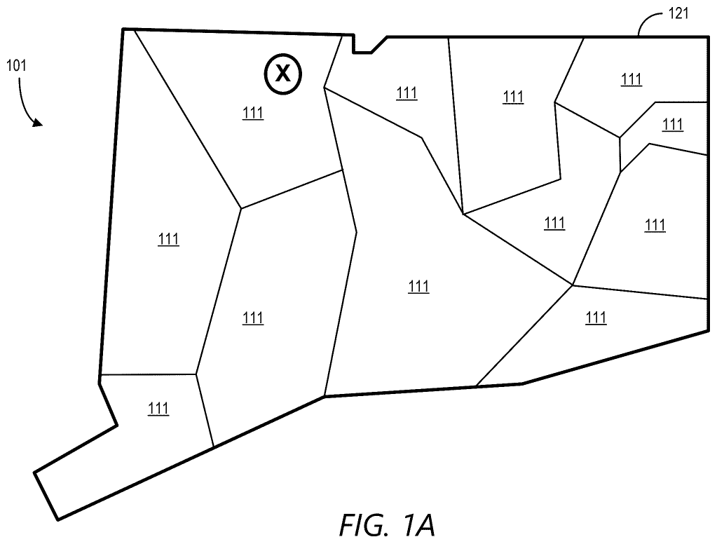

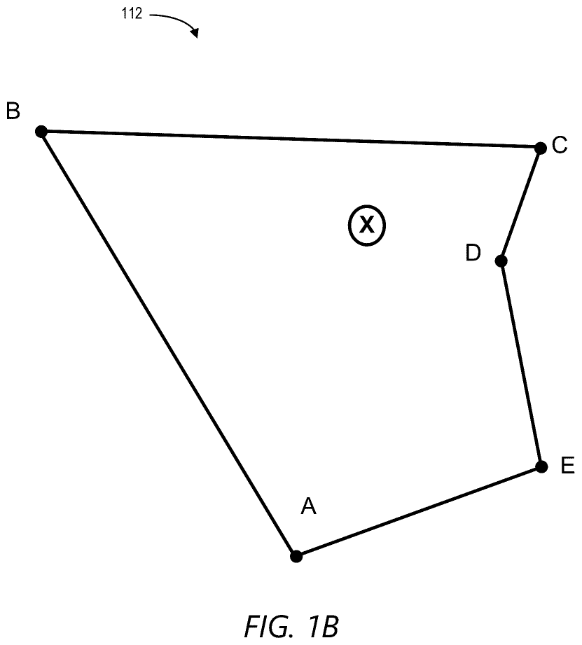

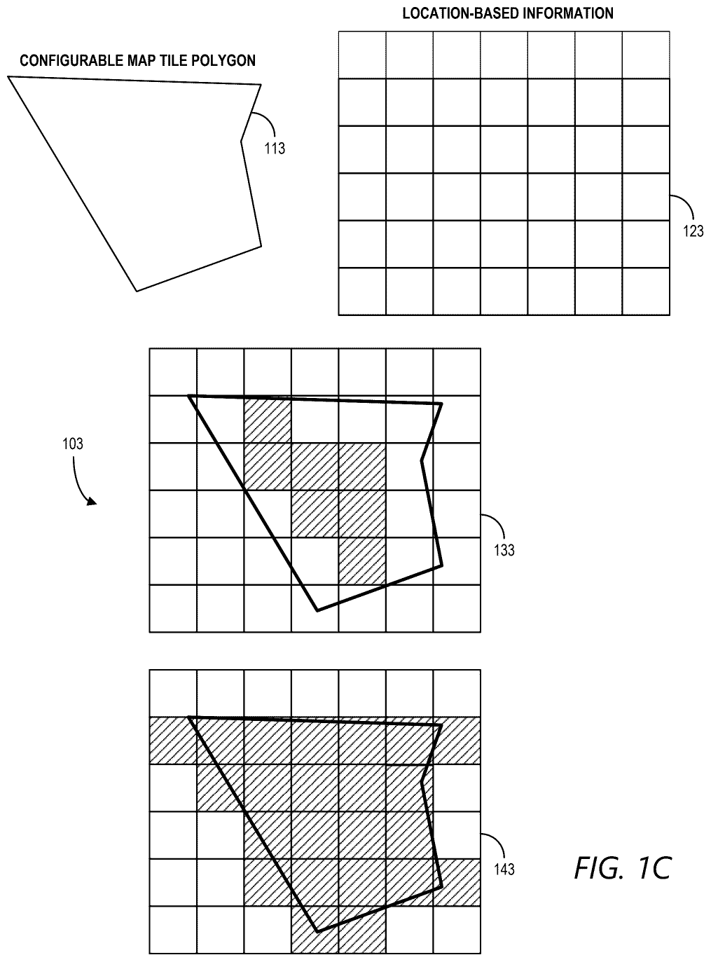

FIG. 1A is a location map 101 in accordance with some embodiments. In particular, the map 101 includes a number of configurable two-dimensional map tile polygons 111 defining the location map 101 having a map border 121. As used herein, the term “polygon” may refer to any plane figure made up of line segments connected to form a closed polygonal chain. The segments of a closed polygonal chain are called “edges” or “sides.: The points where two edges meet are the polygon's “vertices” or “corners.” The polygons 111 are “configurable” in that they can be defined to be of any shape or size. Consider for example, the map tile polygon 111 labeled “X” in FIG. 1A. In particular, FIG. 1B is a configurable map tile polygon 112 according to some embodiments. The tile polygon 112 may be defined by a set of five corner locations (A through E) with pairs of locations defining one of the five sides of the polygon 112. Each location might be defined, for example, with a pair cartesian coordinates, such as:

$$( {X}_{A} , {Y}_{A} ) , ( {X}_{B} , {Y}_{B} ) , ... ( {X}_{E} , {Y}_{E} )$$

According to some embodiments, the locations may be defined by a latitude and longitude (e.g., a latitude of 41.769300 and a longitude of −72.685940) or GPS coordinates (e.g., 41° 46′ 9.48″ N and 720 41′ 9.384″ W).

FIG. 1C illustrates 103 overlaying and correlating information according to some embodiments. A configurable map tile polygon 113 and location-based information 123 may be overlaid. Although a grid-style location-based information 123 arrangement of squares is illustrated in FIG. 1C, embodiments may utilize any other arrangement of information. Any number of techniques can then be used to correlate the information. For example, a first technique 133 might select location-based information squares only if the entire square is within the configurable map tile polygon (as illustrated by cross-hatching). A second technique 143 might select location-based information squares if any portion of the square is within the configurable map tile polygon (as illustrated by cross-hatching). Each square might be associated with a value, and the values of selected squares can then be summed, averaged, etc.

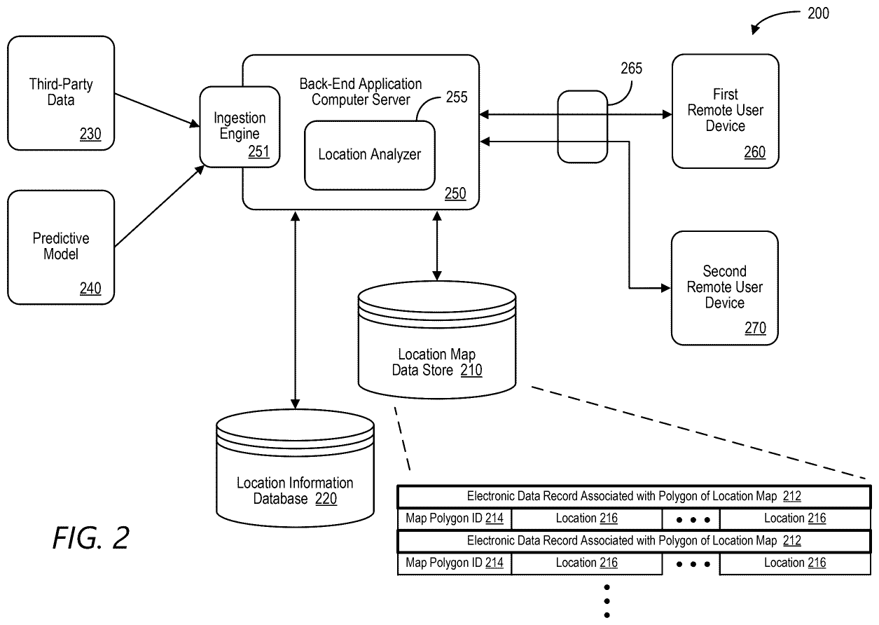

Some embodiments described herein provide for automated location-based analysis tool using such polygons 112. FIG. 2 is a high-level block diagram of a location-based analysis system 200 that may be provided according to some embodiments of the present invention. In particular, the system 200 includes a back-end application computer server 250 that may access information in a location map data store 210 (e.g., storing a set of electronic records associated with a polygon of a location 212, each record including, for example, a map polygon identifier 214 and location values 216). The back-end application computer server 250 may also store information into other data stores, such as a location information database 220, and utilize an ingestion engine 251 and a location analyzer 255 to exchange and process messages and view, analyze, and/or update electronic records. The back-end application computer server 250 may also exchange information with a first remote user device 260 and a second remote user device 270 (e.g., via a firewall 265). According to some embodiments, an interactive graphical user interface platform of the back-end application computer server 250 may facilitate the creation and review of location-based analysis information, recommendations, alerts, and/or the display of results via one or more remote administrator computers (e.g., to summarize system 200 performance) and/or the remote user devices 260, 270. For example, the first remote user device 260 may transmit annotated and/or updated information to the back-end application computer server 250. Based on the updated information, the back-end application computer server 250 may adjust data in the location map data store 210 and/or the location information database 220 and the change may (or may not) be used in connection with the second remote user device 270. Note that the back-end application computer server 250 and/or any of the other devices and methods described herein might be associated with a third party, such as a vendor that performs a service for an enterprise. In some cases, the ingestion engine 251 may receive information about third-party date 230 (e.g., satellite information, census data, public records) and/or a predictive model 240.

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records in the data stores 210, 220 and/or the management of map information. As used herein, the term “automated” may refer to, for example, actions that can be performed with little (or no) intervention by a human.

Devices, including those associated with the back-end application computer server 250 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the location map data store 210 and/or the location information database 220. The data stores 210, 220 may be locally stored or reside remote from the back-end application computer server 250. As will be described further below, the location map data store 210 may be used by the back-end application computer server 250 in connection with an interactive user interface to facilitate location-based analysis for an enterprise. Although a single back-end application computer server 250 is shown in FIG. 2, any number of such devices may be included. Moreover, various devices described herein might be combined according to embodiments of the present invention. For example, in some embodiments, the back-end application computer server 250 and location map data store 210 might be co-located and/or may comprise a single apparatus.

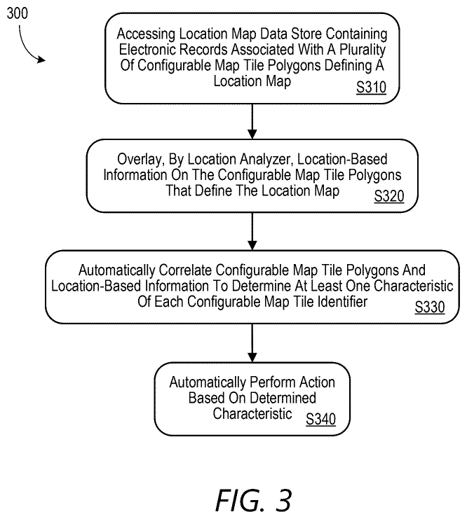

The elements of the system 200 may work together to perform the various embodiments of the present invention. Note that the system 200 of FIG. 2 is provided only as an example, and embodiments may be associated with additional elements or components. According to some embodiments, the elements of the system 200 automatically transmit information associated with an interactive user interface display over a distributed communication network. FIG. 3 illustrates a method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, the system may access a location map data store that contains electronic records associated with a plurality of configurable map tile polygons defining a location map. Each record may include a unique map tile identifier and a set of locations representing sides of a polygon for that configurable map tile.

At S320, the system may overlay location-based information on the configurable map tile polygons that define the location map. The location-based information might comprise, for example, a distance to a resource (e.g., how close is the location to the nearest hospital or fire station), a distance to a danger (e.g., a geographic fault line), historical information (e.g., a monetary amount or total number of insurance claims that were filed), predictive information (e.g., a future conditional of the location), etc. According to some embodiments, the location-based information is received or stored as another location map (e.g., with map tile polygons having different shapes and/or sizes as compared to the map being analyzed).

At S330, the system may automatically correlate the configurable map tile polygons that define the location map and the location-based information to determine at least one characteristic of each configurable map tile identifier. The determined characteristic of each configurable map tile identifier might be associated with, for example, a monetary value, a predicted result, a recommended action (e.g., a letter should be mailed to all customers within a polygon), an intended use (retails stores or playground), a status (e.g., a landmark building designation or a hazardous material site), etc.

At S340, the system automatically performs an action based on the determined characteristic. The automatically performed action might comprise, for example, establishing a communication link and/or transmitting an alert message (e.g., a flood warning). As other examples, automatically performed action might be associated with, for example, initiating an enterprise workflow (e.g., to manually review insurance policies for customers within a certain area, creating a calendar item (e.g., to schedule a telephone call to a potential client), generating a report (e.g., summarizing results), updating a predictive model, creating a recommendation using artificial intelligence, etc.

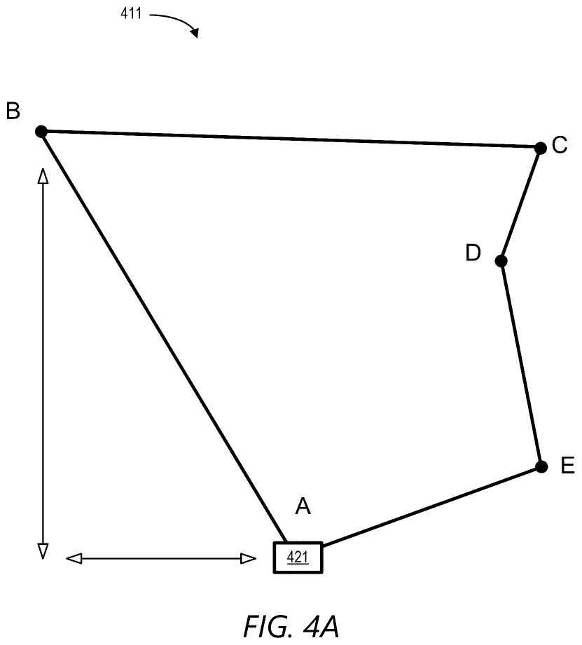

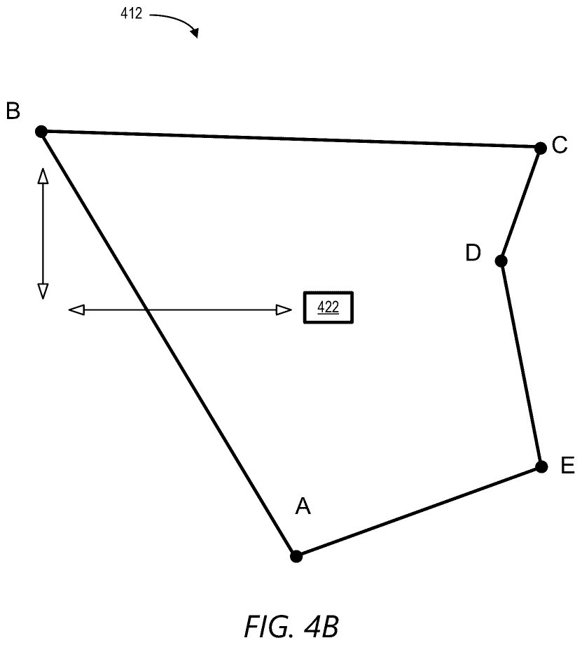

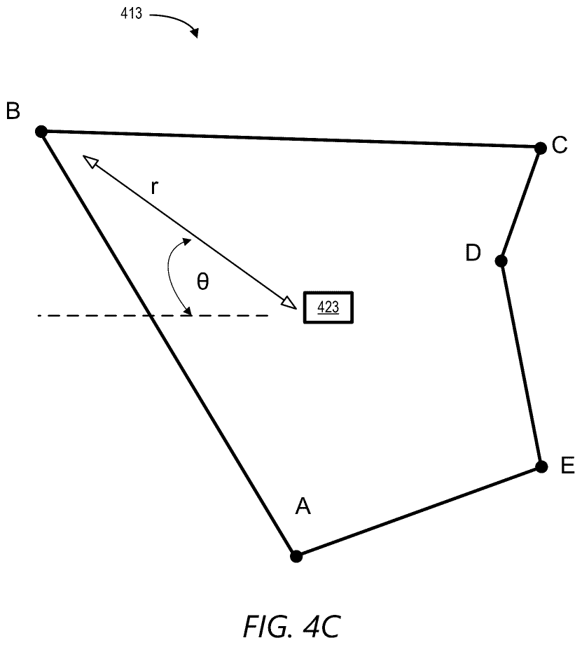

Note that the definition of a polygon described in connection with FIG. 1B is provided only as an example, and embodiments may define corners or sides in any number of different ways. For example, FIGS. 4A through 4C are various ways of configuring a map tile polygon in accordance with some embodiments. In particular, FIG. 4A shows that a polygon 411 definition could include the cartesian coordinates of only a single polygon corner 421 (A) while the other polygon corners (B through E) are provided as ΔX, ΔY differences from that location (or from the prior corner in a chain). FIG. 4B shows that a polygon 412 definition might include the cartesian coordinates of a single polygon centroid 422 (A) while the other polygon corners (B through E) are provided as ΔX, ΔY differences from that location. As still another example, FIG. 4C shows that a polygon 413 definition might include the cartesian coordinates of only a single polygon corner 423 (A) while the other polygon corners (B through E) are provided as r, e polar coordinates from that location. Any number of other techniques might be used instead.

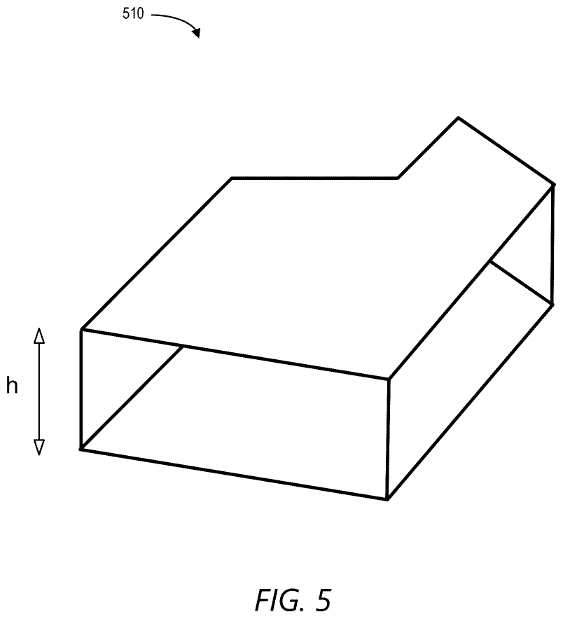

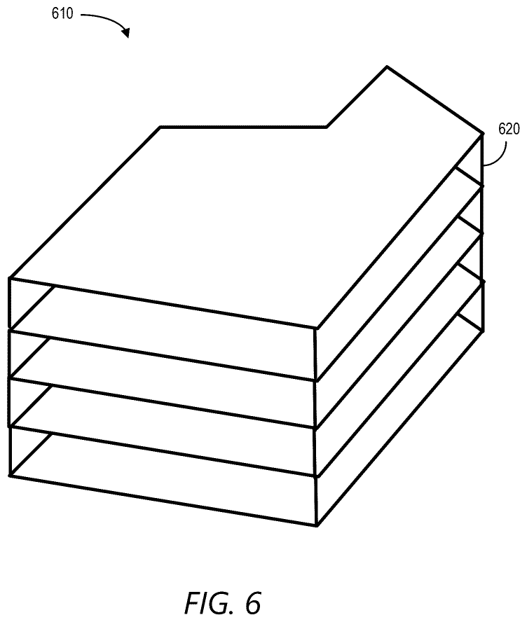

The previously described map tile programs have been two dimensional. According to some embodiments, the location map comprises a three-dimensional volume. FIG. 5 is a three-dimensional map tile polygon 510 according to some embodiments. In this case, the map tile polygon 510 might be associated with a height h. The height might be, for example, a distance (e.g., above ground level), number of building stories, weather information, and/or a negative value (e.g., information about underground conditions). In some embodiments, the location map data store contains a plurality of layered location maps. For example, FIG. 6 shows 610 map tile polygon layers 620 in accordance with some embodiments. In other embodiments, more complex three-dimensional volumes may be utilized (e.g., a location map tile might be a polyhedron defined as three-dimensional shape whose faces are each a polygon).

In some embodiments, the layers 620 represent different physical spaces. In other embodiments, one or more layer 620 do not represent different physical spaces. For example, one layer 620 might be associated with a virtual reality location such as those associated with augmented reality. As used herein, the phrase “augmented reality” may refer to an interactive experience that combines the real world and computer-generated content. Such a system may incorporate a combination of real and location-based virtual items with real-time interaction. For example, an augmented reality game might incorporate virtual items (e.g., game characters or messages) that are interwoven with the physical world such that they are perceived as an immersive aspect of the real environment. An augmented reality game that is popular with young people might substantially alter a location's retail characteristics, foot traffic, etc.

According to some embodiments, a location map is associated with a parent-child hierarchy of location maps. For example, FIG. 7 is a map tile polygon hierarchy 700 according to some embodiments. That is, each polygon 710 in a location map 711 might be comprised of a set of sub-polygons 712 forming a hierarchical model. Examples might include countries, states, counties, ZIP codes, census tracts, land parcels, buildings, etc.

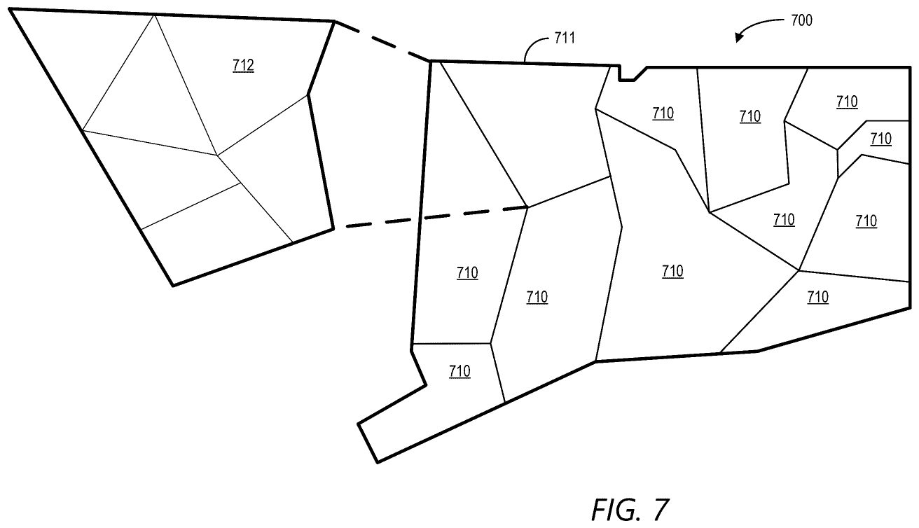

The map tile polygon previously described might be thought of as “permanent” locations (or perhaps “semi-permanent” since a building might be torn down, a park might be converted into a shopping mall, etc.). In some embodiments, temporary and/or moving locations might be provided. For example, FIG. 8 shows 800 a location map 820 formed of polygons 810 and one temporary map tile polygon 830 is provided in accordance with some embodiments. The temporary location might be associated with, for example, weather, a hurricane, hail, a tornado (e.g., moving 840 in a particular direction and at a particular speed), a flood, a wildfire, etc. In some embodiments the temporary location might represent legislative changes (e.g., a minimum driving age), legislative rules or regulations, etc.

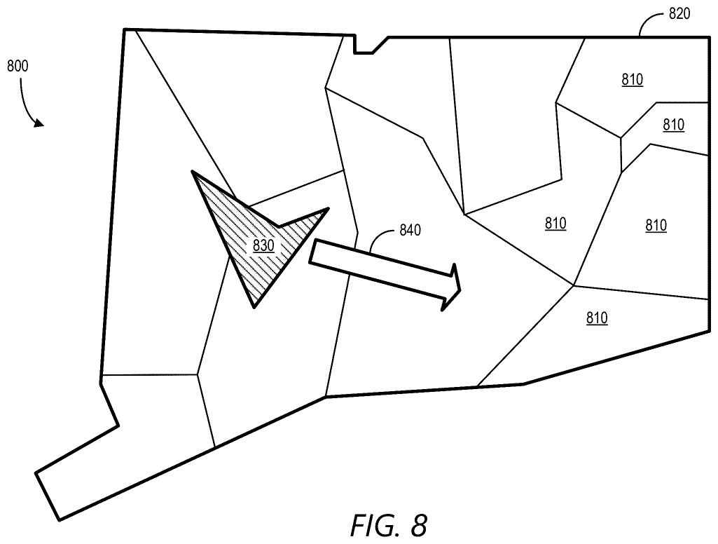

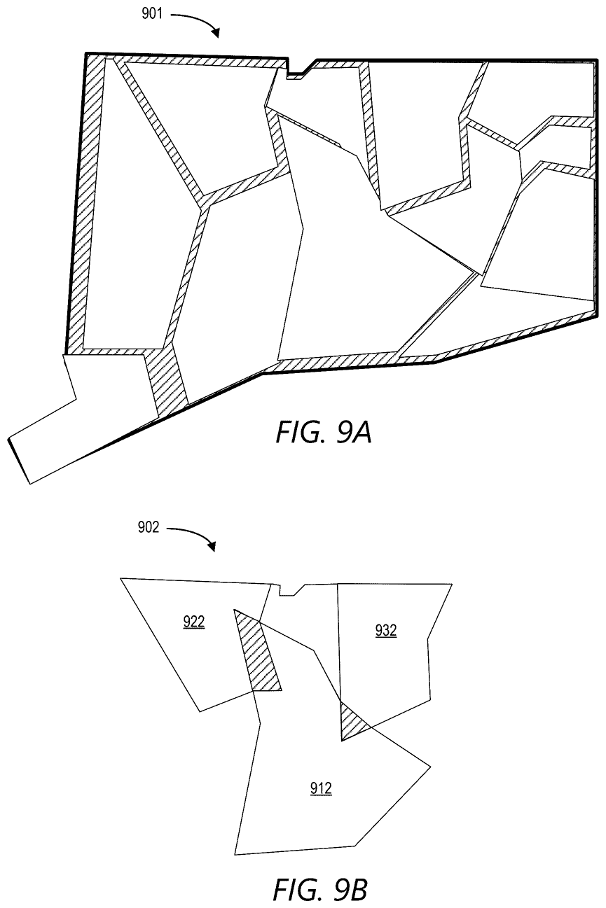

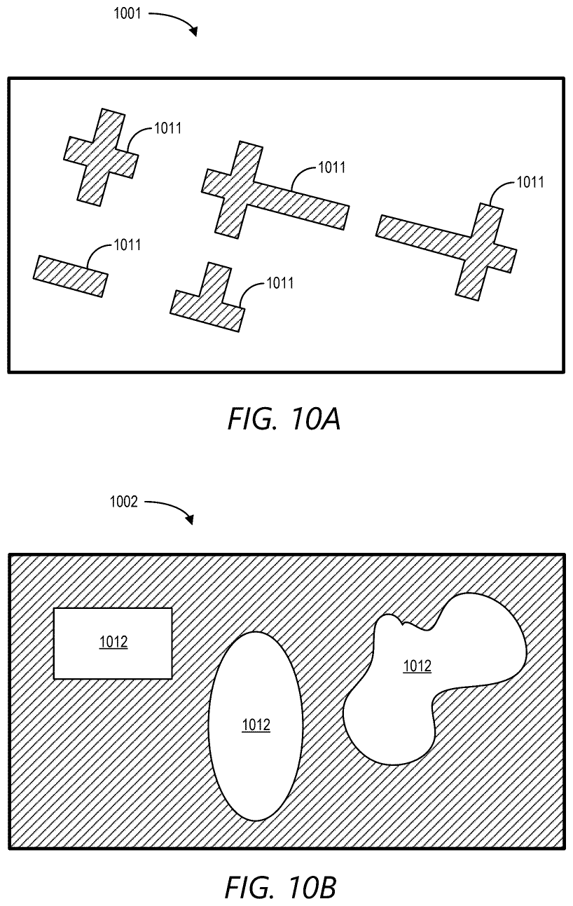

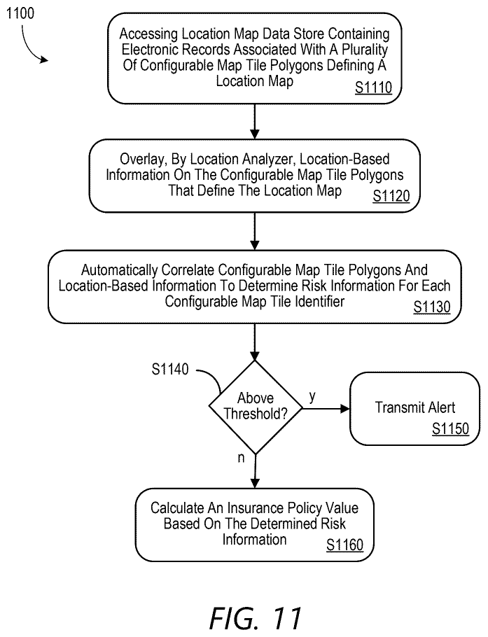

The previously described location maps were formed of map tile polygons that “fit together” perfectly like puzzle pieces. FIGS. 9A and 9B are illustrations of location maps according to some other embodiments. In particular, FIG. 9A shows 901 that gaps might exist between the map tile polygons (shown as cross-hatched areas in FIG. 9A), and FIG. 9B shows 902 that overlaps could occur between the map tile polygons (e.g., map tile polygon 912 overlays both polygon 922 and polygon 932 over as illustrated by cross-hatched areas in FIG. 9B). FIGS. 10A and 10B are tile polygons in accordance with still other embodiments. In particular, FIG. 10A is a location map 1001 with map tile polygons 1011 that are associated with street intersections (e.g., especially dangerous intersections that have resulted in an unusually large number of traffic accidents). FIG. 10B is a location map 1002 with subtractive map tile polygons 1012 (e.g., areas 1012 have been removed from the map 1002 as illustrated by cross-hatching in FIG. 10B).

FIG. 11 is an insurance related method 1100 according to some embodiments. As before, the system may access a location map data store that contains electronic records associated with a plurality of configurable map tile polygons defining a location map at S1110. Each record may include a unique map tile identifier and a set of locations representing sides of a polygon for that configurable map tile. At S1120, the system may overlay location-based information on the configurable map tile polygons that define the location map. At S1130, the system automatically correlates the configurable map tile polygons that define the location map and the location-based information to determine risk information (e.g., a level of risk) for each configurable map tile identifier, etc.

If the determined risk information is above a pre-determined threshold value at S1140, the system automatically transmits an alert at S1150 (e.g., via telephone calls to customers). The level of risk may be used at S1160, for example, to determine a resource value for a risk relationship between an enterprise and a party associated with a particular configurable map tile identifier. According to some embodiments, the resource value might comprise, for example, an insurance premium for an insurance policy associated with workers' compensation insurance, health insurance, vehicle insurance, property insurance, business insurance, etc.

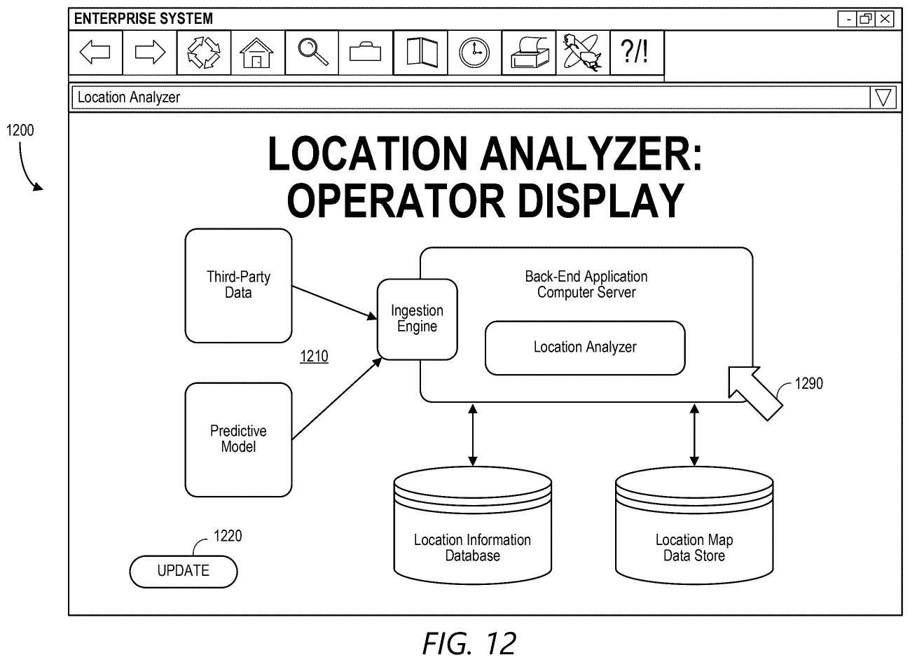

The operation of an enterprise location analyzer may be controlled via a Graphical User Interface (“GUI”). For example, FIG. 12 is an enterprise location analyzer system operator or administrator display 1200 including graphical representations of elements of such a tool 1210 according to some embodiments. Selection of a portion or element of the display 1200 via a touchscreen or pointer 1290 might result in the presentation of additional information about that portion or element (e.g., a popup window presenting data mappings, location analysis details, etc.) or let an operator or administrator enter or annotate additional information about location analysis (e.g., based on changes to a system configuration, new location-based third party data, etc.). An “Update” icon 1220 might let the administrator save updates and changes to the tool 1210.

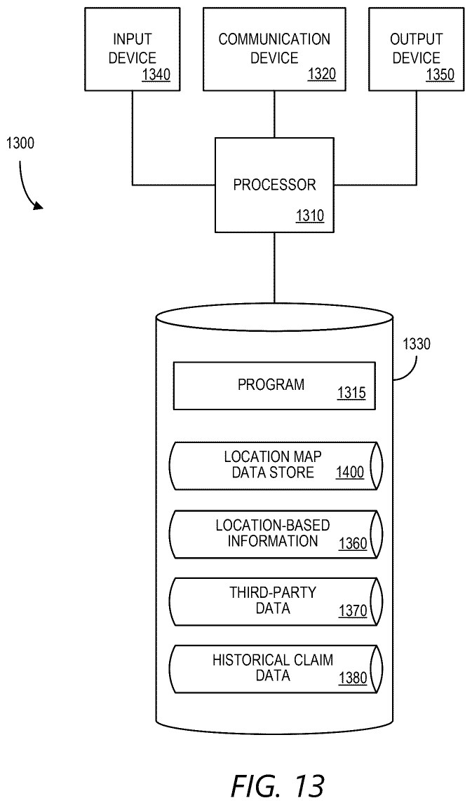

The embodiments described herein may be implemented using any number of different hardware configurations. For example, FIG. 13 illustrates an apparatus 1300 that may be, for example, associated with the system 200 described with respect to FIG. 2 (or any other system described herein). The apparatus 1300 comprises a processor 1310, such as one or more commercially available Central Processing Units (“CPUs”) in the form of one-chip microprocessors, coupled to a communication device 1320 configured to communicate via a communication network (not shown in FIG. 13). The communication device 1320 may be used to communicate, for example, with one or more remote cloud or on-premises systems, administrators, customers, and/or communication devices (e.g., PCs and smartphones). Note that communications exchanged via the communication device 1320 may utilize security features, such as those between a public internet user and an internal network of an insurance company and/or an enterprise. The security features might be associated with, for example, web servers, firewalls, and/or PCI infrastructure. The apparatus 1300 further includes an input device 1340 (e.g., a mouse and/or keyboard to enter information about location maps, analysis requests, etc.) and an output device 1350 (e.g., to output reports regarding enterprise location-based analysis, recommendations, alerts, etc.).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1315 and/or a location-based analysis tool or application for controlling the processor 1310. The processor 1310 performs instructions of the program 1315, and thereby operates in accordance with any of the embodiments described herein. For example, the processor 1310 may overlay location-based information on the configurable map tile polygons that define the location map. The processor 1310 can then automatically correlate the configurable map tile polygons that define the location map and the location-based information to determine at least one characteristic of each configurable map tile identifier. According to some embodiments an action is automatically performed by the processor 1310 based on the determined characteristic.

The program 1315 may be stored in a compressed, uncompiled and/or encrypted format. The program 1315 may furthermore include other program elements, such as an operating system, a database management system, and/or device drivers used by the processor 1310 to interface with peripheral devices.

As used herein, information may be “received” by or “transmitted” to, for example: (i) the apparatus 1300 from another device; or (ii) a software application or module within the apparatus 1300 from another software application, module, or any other source.

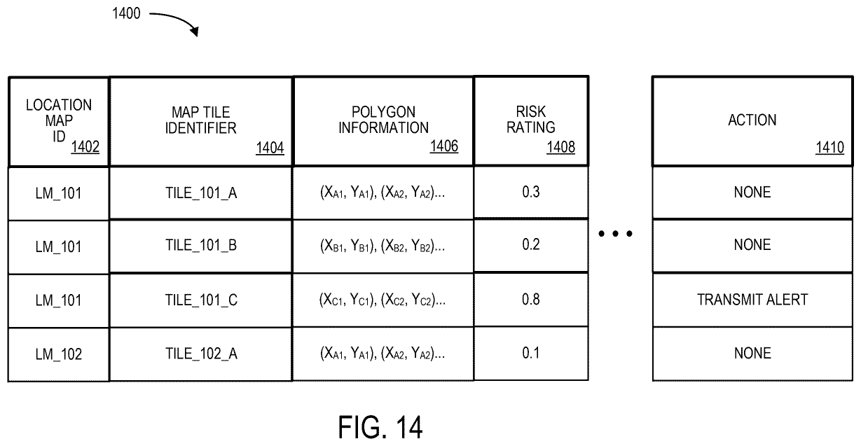

In some embodiments (such as shown in FIG. 13), the storage device 1330 further includes a location map data store 1400, location-based information, third-party data 1370 (e.g., satellite information, legislative updates, etc.), and historical claim data 1380 (e.g., insurance claims that have been filed for various locations). An example of a database that might be used in connection with the apparatus 1300 will now be described in detail with respect to FIG. 14. Note that the database described herein is only an example, and additional and/or different information may be stored therein. Moreover, various databases might be split or combined in accordance with any of the embodiments described herein. For example, the location-based information 1360 and historical claim data 1380 might be combined and/or linked to each other within the program 1315.

Referring to FIG. 14, a table is shown that represents the location map data store 1400 that may be stored at the apparatus 1300 according to some embodiments. The table may include, for example, entries associated with a location map to be analyzed. The table may also define fields 1402, 1404, 1406, 1408, 1410 for each of the entries. The fields 1402, 1404, 1406, 1408, 1410 may, according to some embodiments, specify: a location map identifier 1402, a map tile identifier 1404, polygon information 1406, a risk rating 1408, and an action 1410. The location map data store 1400 may be created and updated, for example, when a new area is mapped, a new analysis is requested, etc.

The location map identifier 1402 may be, for example, a unique alphanumeric code associated with a map of a certain location. The map tile identifier 1404 is associated with a configurable map file polygon. The polygon information 1406 defines the corner locations that make up the polygon. The risk rating 1408 may represent a level of risk (e.g., from zero to one, with zero being the lowest risk). The risk rating 1408 may calculated as a result of a location-based analysis of the area associated with that configurable map tile polygon. The action 1410 may be automatically performed based on risk rating 1408 (e.g., the action may be to transmit an alert message when the risk rating 1408 rises about a pre-determined threshold value).

Thus, embodiments may provide improved systems and methods to accurately and/or automatically support location-based analysis for an enterprise.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

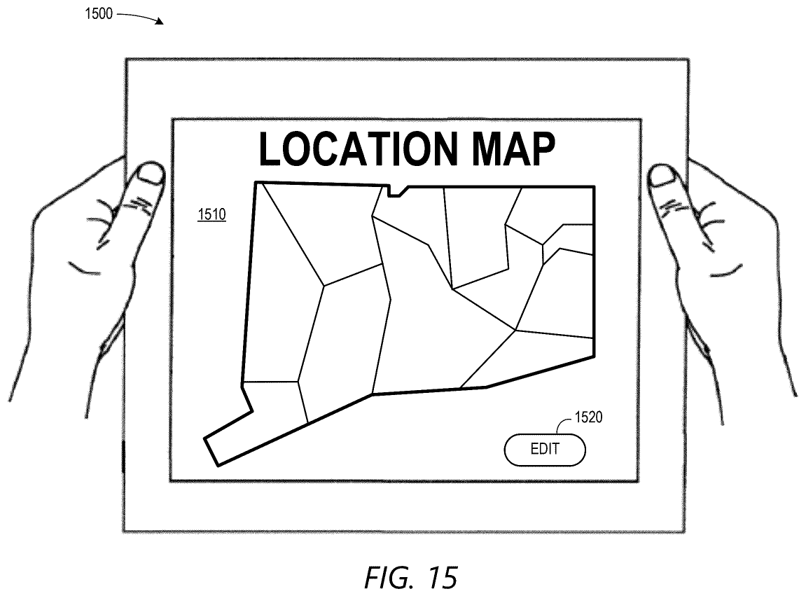

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises, embodiments may instead be associated with other types of insurers, businesses, and organizations instead. FIG. 15 illustrates a handheld tablet 1500 in accordance with some embodiments. A location display 1510 might, for example, let an operator adjust map polygons via an “Edit” icon 1520. Note that embodiments might be associated with any type of business (e.g., insurance companies, financial enterprises, educational institutions, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A system for location-based analytics, comprising:
(a) a location map data store that contains electronic records associated with a plurality of configurable map tile polygons defining a location map, each record including a unique map tile identifier and a set of locations representing sides of a polygon for that configurable map tile; and
(b) a location analyzer, coupled to the location map data store, including:
a computer processor, and
a computer memory coupled to the computer processor and storing instructions that, when executed by the computer processor, cause a back-end application computer server associated with the location analyzer to:
overlay location-based information on the configurable map tile polygons that define the location map,
automatically correlate the configurable map tile polygons that define the location map and the location-based information to determine at least one characteristic of each configurable map tile identifier, and
automatically perform an action based on the determined characteristic.

2. The system of claim 1, wherein the location map is associated with a parent-child hierarchy of location maps.

3. The system of claim 1, wherein the configurable map tile polygons are associated with semi-permanent locations.

4. The system of claim 1, wherein at least one configurable map tile polygon represents a temporary location.

5. The system of claim 4, wherein the temporary location is associated with at least one of: (i) weather, (ii) a hurricane, (iii) hail, (iv) a tornado, (v) a flood, (vi) a wildfire, and (vii) legislative rules or regulations.

6. The system of claim 1, wherein the location map includes at least one of: (i) overlapping configurable map tile polygons, (ii) gaps between configurable map tile polygons, (iii) a subtractive polygon.

7. The system of claim 1, wherein the set of locations representing the sides of a polygon for each configurable map tile comprise at least one of: (i) a set of cartesian coordinates, (ii) a set of latitudes and longitudes, (iii) a set of polar coordinates, (iv) a difference between locations, and (v) a centroid.

8. The system of claim 1, wherein the location-based information comprises at least one of: (i) a distance to a resource, (ii) a distance to a danger, (iii) historical information, (iv) predictive information, and (v) another location map.

9. The system of claim 1, wherein the determined characteristic of each configurable map tile identifier comprises at least one of: (i) a monetary value, (ii) a predicted result, (iii) a recommended action, (iv) an intended use, and (v) a status.

10. The system of claim 1, wherein the determined characteristic of each configurable map tile identifier represents a level of risk.

11. The system of claim 10, wherein the level of risk is used to determine a resource value for a risk relationship between an enterprise and a party associated with a particular configurable map tile identifier.

12. The system of claim 11, wherein the risk relationship comprises an insurance policy associated with at least one of: (i) workers' compensation insurance, (ii) health insurance, (iii) vehicle insurance, (iv) property insurance, and (v) business insurance.

13. The system of claim 1, wherein the location map comprises a three-dimensional volume.

14. The system of claim 13, wherein the location map data store contains a plurality of layered location maps.

15. The system of claim 13, wherein the location map is a polyhedron three-dimensional shape whose faces are polygons.

16. The system of claim 1, wherein the automatically performed action is associated with at least one of: (i) establishing a communication link, (ii) transmitting an alert message, (iii) initiating an enterprise workflow, (iv) creating a calendar item, (v) generating a report, (vi) updating a predictive model, and (vii) creating a recommendation using artificial intelligence.

17. A location-based analytics method, comprising:
accessing a location map data store that contains electronic records associated with a plurality of configurable map tile polygons defining a location map, each record including a unique map tile identifier and a set of locations representing sides of a polygon for that configurable map tile;
overlaying, by a computer processor of a location analyzer in a back-end application computer server, location-based information on the configurable map tile polygons that define the location map;
automatically correlating the configurable map tile polygons that define the location map and the location-based information to determine at least one characteristic of each configurable map tile identifier; and
automatically performing an action based on the determined characteristic.

18. The method of claim 17, wherein the determined characteristic of each configurable map tile identifier represents a level of risk, and the level of risk is used to determine a resource value for a risk relationship between an enterprise and a party associated with a particular configurable map tile identifier.

19. A non-transitory, computer-readable medium storing instructions, that, when executed by a processor, cause the processor to perform a location-based analytics method, the method comprising:
accessing a location map data store that contains electronic records associated with a plurality of configurable map tile polygons defining a location map, each record including a unique map tile identifier and a set of locations representing sides of a polygon for that configurable map tile;
overlaying, by a computer processor of a location analyzer in a back-end application computer server, location-based information on the configurable map tile polygons that define the location map;
automatically correlating the configurable map tile polygons that define the location map and the location-based information to determine at least one characteristic of each configurable map tile identifier; and
automatically performing an action based on the determined characteristic.

20. The medium of claim 19, wherein the location map is associated with a parent-child hierarchy of location maps.
